(19) United States
(12) Patent Application Publication
(10) Pub. No.: US 2018/0083808 A1
(43) Pub. Date: Mar. 22, 2018

(54) ENHANCED MULTI-USER MIMO DETECTION

(71) Applicant: QUALCOMM Incorporated, San Diego, CA (US)

(72) Inventors: Louay Jalloul, San Jose, CA (US); Ahmad Abdulrahman Mohammed, San Jose, CA (US)

(21) Appl. No.: 15/269,661

(22) Filed: Sep. 19, 2016

(51) Int. Cl. H04L 25/03; H04B 7/04; H04L 12/26

(52) U.S. Cl. CPC H04L 25/03993; H04W 88/08; H04L 43/16; H04B 7/0452

(57) ABSTRACT

Apparatuses and methods are disclosed for receiving or obtaining wireless signals. A first wireless device may receive a wireless signal including a first signal and a number of second signals. The first signal may contain data intended for the first wireless device, and the number of second signals may contain data intended for one or more second wireless devices. The first wireless device may select one or more of the number of second signals, determine a pre-whitening matrix based on an interference and noise covariance of the unselected second signals, and recover the first signal by using the pre-whitened signal.

### TECHNICAL FIELD

The present disclosure relates generally to wireless networks, and more particularly to multiple-input multiple output (MIMO) communications.

### BACKGROUND

A wireless local area network (WLAN) may be formed by one or more access points (APs) that provide a shared wireless communication medium for use by a number of client devices such as mobile stations (STAs). Multiple-input multiple-output (MIMO) signaling techniques allow an AP to transmit data to the STAs using multiple spatial streams, which may provide many advantages (e.g., higher throughput, extended coverage, increased diversity, and/or interference suppression) over conventional single antenna transmission techniques. For one example, in a single-user MIMO (SU-MIMO) environment, the AP may use a plurality of antennas to transmit data to a single STA using multiple spatial streams, and the STA may use a plurality of antennas to receive the multiple spatial streams. The STA may recover the original data by decoding the received multiple spatial streams.

For another example, in a multi-user MIMO (MU-MIMO) environment, the AP may use a plurality of antennas to transmit data to multiple STAs at the same time using multiple spatial streams, and each of the multiple STAs may use a number of antennas to receive one or more of the spatial streams containing data intended for the respective STA. Because each STA may receive all of the spatial streams transmitted by the AP, it is important that the STA distinguish between spatial streams containing data intended for the STA and spatial streams containing data intended for other STAs.

Conventional receivers may treat spatial streams intended for other STAs as interference typically associated with white noise, and may attempt to detect and/or filter these other spatial streams in a manner similar to that typically used to filter or suppress white noise. However, because spatial streams intended for other STAs may occupy different portions of the frequency spectrum than white noise (and may include signal characteristics more similar to the spatial streams intended for the STA than to signal characteristics of white noise), it would be desirable for receivers used in MU-MIMO communications to more effectively distinguish between spatial streams containing data intended for a given STA and spatial streams containing data intended for other STAs.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Apparatuses and methods are disclosed for receiving wireless signals in a wireless communication network or system. In one aspect, an apparatus for wireless communication is disclosed. The apparatus may include an interface and a processing system. The interface may be configured to obtain a wireless signal including a first signal and a number of second signals. The processing system may be configured to select one or more of the number of second signals; determine a pre-whitening matrix based on an interference and noise covariance of the unselected second signals; generate a pre-whitened signal by applying the pre-whitening matrix to the wireless signal; and recover the first signal by using the pre-whitened signal.

In another aspect, a method for wireless communication is disclosed. The method may include obtaining a wireless signal including a first signal and a number of second signals; selecting one or more of the number of second signals; determining a pre-whitening matrix based on an interference and noise covariance of the unselected second signals; generating a pre-whitened signal by applying the pre-whitening matrix to the wireless signal; and recovering the first signal by using the pre-whitened signal.

In another aspect, an apparatus is disclosed. The apparatus may include means for obtaining a wireless signal including a first signal and a number of second signals; means for selecting one or more of the number of second signals; means for determining a pre-whitening matrix based on an interference and noise covariance of the unselected second signals; means for generating a pre-whitened signal by applying the pre-whitening matrix to the wireless signal; and means for recovering the first signal by using the pre-whitened signal.

In another aspect, a computer-readable medium is disclosed. The computer-readable medium may comprise instructions that, when executed by an apparatus, cause the apparatus to obtain a wireless signal including a first signal and a number of second signals; select one or more of the number of second signals; determine a pre-whitening matrix based on an interference and noise covariance of the unselected second signals; generate a pre-whitened signal by applying the pre-whitening matrix to the wireless signal; and recover the first signal by using the pre-whitened signal.

In another aspect, a wireless node is disclosed. The wireless node may comprise a receiver and a processing system. The receiver may be configured to obtain a wireless signal including a first signal and a number of second signals. The processing system may be configured to select one or more of the number of second signals; determine a pre-whitening matrix based on an interference and noise covariance of the unselected second signals; generate a pre-whitened signal by applying the pre-whitening matrix to the wireless signal; and recover the first signal by using the pre-whitened signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a multiple-input multiple-output (MIMO) wireless system within which various aspects of the present disclosure may be implemented.

FIG. 2 shows a block diagram of an access point and a number of user terminals that may be implemented in a MIMO wireless system.

FIG. 3 shows a block diagram of a wireless device in accordance with various aspects of the present disclosure.

FIG. 4 shows a block diagram of an access point (AP) in accordance with various aspects of the present disclosure.

FIG. 5A shows a block diagram of an example circuit for receiving or obtaining a wireless signal, in accordance with various aspects of the present disclosure.

FIG. 5B shows a block diagram of an example circuit for receiving or obtaining a wireless signal, in accordance with various aspects of the present disclosure.

FIG. 6 shows a block diagram of an example circuit for receiving or obtaining a wireless signal, in accordance with various aspects of the present disclosure.

FIG. 7A shows a block diagram of an example circuit for receiving or obtaining a wireless signal, in accordance with various aspects of the present disclosure.

FIG. 7B shows a block diagram of an example circuit for receiving or obtaining a wireless signal, in accordance with various aspects of the present disclosure.

FIG. 8 shows an illustrative flow chart depicting example operations for receiving or obtaining a wireless signal, in accordance with various aspects of the present disclosure.

FIG. 9 shows an example high efficiency (HE) packet that may be used in accordance with various aspects of the present disclosure.

FIG. 10 depicts an example HE preamble that may be used in accordance with various aspects of the present disclosure.

### DETAILED DESCRIPTION

A wireless device may receive a signal that contains not only data intended for the wireless device but also data intended for other wireless devices. For example, in a wireless network for which multiple spatial streams containing data intended for multiple users or wireless devices may be transmitted concurrently, a given wireless device may receive all of the transmitted spatial streams. Thus, it is important that the given wireless device distinguish between signals or spatial streams containing data intended for the given wireless device and signals or spatial streams containing data intended for other wireless devices. Techniques, devices, systems, and methods described herein may allow a wireless device to more effectively distinguish between signals or spatial streams containing data intended for the wireless device and signals or spatial streams containing data intended for other wireless devices (e.g., as compared with conventional techniques).

Aspects of the present disclosure are described below in the context of WLAN systems for simplicity only. It is to be understood that aspects of the present disclosure are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, aspects of the present disclosure are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, aspects of the present disclosure may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. Further, spatial streams or signals containing data intended for a given user or wireless device may be referred to herein as “desired signals,” and spatial streams or signals containing data intended for other users or other wireless devices may be referred to herein as “interfering signals.”

In addition, as used herein, a received signal may be considered to be “white” if each sample of the signal is independent statistically from every other sample of the signal. A “whitening operation” as used herein may refer to a linear transformation of a vector of random variables with a known covariance matrix into a set of new variables whose covariance is the identity matrix (e.g., the new variables are uncorrelated and thus all have variance). A “pre-whitening matrix” as used herein refers to a matrix that may be applied to an input signal to convert the input signal into white noise.

In some implementations, wireless signals may be transmitted according to a high efficiency (HE) wireless protocol defined, for example, by the IEEE 802.11 ax specification. The HE wireless protocol, which may also be referred to as the high efficiency wireless (HEW) protocol, may use orthogonal frequency-division multiplexing (OFDM) communications, direct-sequence spread spectrum (DSSS) communications, a combination of OFDM and DSSS communications, and/or other suitable communication techniques. Wireless communications implemented according to the HEW protocol, which may be used for Internet access, sensors, metering, smart grid networks, and/or other wireless applications, may consume less power and/or may be more robust against signal interference (e.g., caused by objects such as humans) than wireless communications according to other wireless protocols.

Also, in the following description and for purposes of explanation, specific nomenclature is set forth to provide a thorough understanding of various aspects of the present disclosure. However, it will be apparent to one skilled in the art that these specific details may not be required to practice the methods are apparatuses disclosed herein. In other instances, well-known circuits and devices are shown in block diagram form to avoid obscuring the present disclosure. The present disclosure is not to be construed as limited to specific examples described herein but rather to include within their scopes all implementations defined by the appended claims.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

As mentioned above, MU-MIMO communications may allow an AP to transmit data to a plurality of different users at the same time, for example, using multiple spatial streams. These different users may be referred to herein as “co-scheduled users.” A wireless device may receive MU-MIMO communications that include spatial streams containing data intended for a user of the wireless device, spatial streams containing data intended for other co-scheduled users (e.g., the interfering signals), and noise. The interfering signals typically occupy different portions of the frequency spectrum than white noise, and therefore detecting and/or filtering these interfering signals using techniques intended to filter white noise may not provide a desired level of distinction between spatial streams containing data intended for the wireless device and spatial streams containing data intended for other wireless devices. These are at least some of the technical problems to be solved by aspects of the present disclosure.

In accordance with aspects of the present disclosure, a receiver of a wireless device may utilize the structure and/or signal characteristics of spatial streams used in MU-MIMO communications to distinguish between spatial streams containing data intended for a given user and spatial streams containing data intended other co-scheduled users. More specifically, the receivers disclosed herein may employ pre-whitening techniques that account for the structure and/or signal characteristics of these other spatial streams (e.g., the “interfering signals”) rather than processing these interfering signals as white noise. For some implementations, a wireless device may determine a pre-whitening matrix to apply to received signals, use the pre-whitening matrix to whiten one or more of the received signals and their corresponding channel responses, and then recover data intended for the wireless device while ignoring (e.g., filtering) data intended for other wireless devices. In some aspects, the wireless device may select a number of these other spatial streams, and then determine the pre-whitening matrix based on an interference and noise covariance of the unselected ones of these other spatial streams. Because the pre-whitening matrix is determined without using (e.g., by excluding) the interference and noise covariance of the selected spatial streams, pre-whitening operations performed on the received signal may not process the selected interfering signals as white noise, which in turn may allow spatial stream detection to be based on the structure and/or signal characteristics of the selected interfering signals. These and other details of the present disclosure, which provide one or more technical solutions to the aforementioned technical problems, are described in more detail below.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

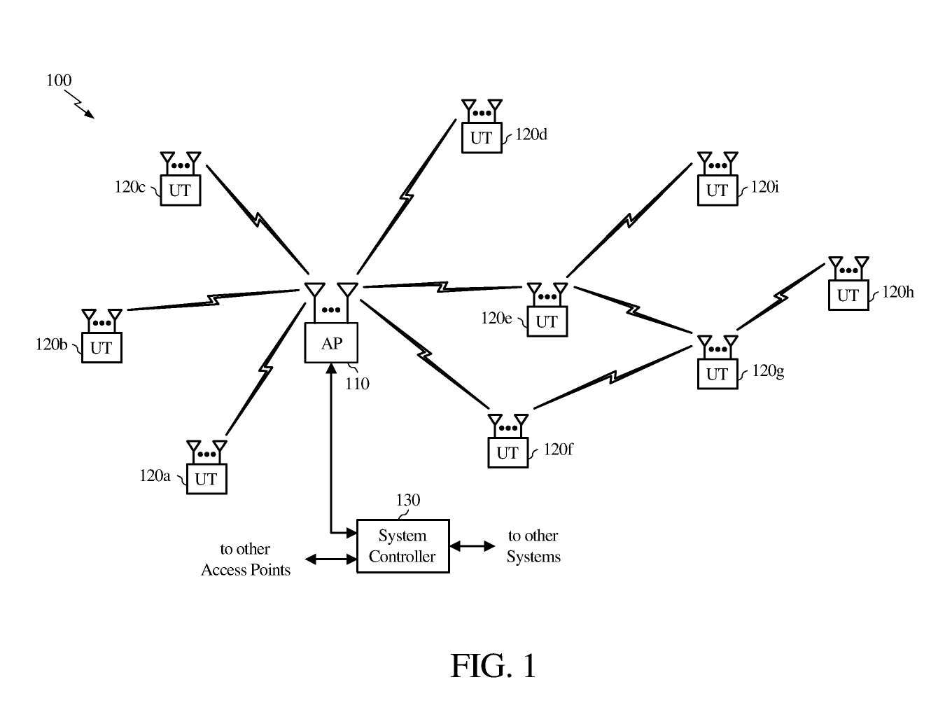

FIG. 1 shows an example wireless system 100 including an access point 110 and a number of user terminals 120. For simplicity, only one access point 110 is shown in FIG. 1. An access point, which is generally a fixed station that communicates with the user terminals 120, may also be referred to as a base station or a wireless device. A user terminal, which may be fixed or mobile, may also be referred to as a mobile station (STA) or a wireless device. The access point 110 may communicate with one or more user terminals 120 via downlink channels and/or uplink channels. The downlink channel (e.g., forward link) represents the communication link from the access point 110 to the user terminals 120, and the uplink channel (e.g., reverse link) represents the communication link from the user terminals 120 to the access point 110. A user terminal 120 may also communicate with another user terminal 120 using peer-to-peer communication techniques. A system controller 130 may provide coordination and control for the access point 110 and/or for other access points within or otherwise associated with the wireless system 100 (other access points not shown for simplicity).

For implementations in which one or more of the user terminals 120 may not support space-division multiple access (SDMA) signaling techniques, the access point 110 may be configured to communicate with both SDMA user terminals and non-SDMA user terminals. In this manner, the access point 110 may allow older versions of user terminals (e.g., “legacy” stations) that do not support SDMA signaling techniques to remain deployed in the wireless system 100 while allowing newer user terminals that support SDMA signaling techniques to be deployed within the wireless system 100.

The access point 110 may include a number (Nₐₚ) of antennas to facilitate multiple-input (MI) downlink transmissions and multiple-output (MO) uplink transmissions for the wireless system 100. A set (K) of selected user terminals 120 may collectively provide multiple-output downlink transmissions and multiple-input uplink transmissions for the wireless system 100. For SDMA communications, the number of antennas on the access point 110 may be greater than or equal to the number of selected user terminals 120 (e.g., Nₐₚ≧K≧1) when the data streams for the K user terminals 120 are not multiplexed in code, frequency, or time. The number of selected user terminals 120 may be greater than the number of antennas on the access point 110 (e.g., K>Nₐₚ) when the data streams are multiplexed (e.g., using time-division multiple access (TDMA), code-division multiple access (CDMA), orthogonal frequency-division multiple access (OFDMA), and/or other suitable multiple-access signaling techniques). Each selected user terminal 120 may transmit user-specific data to and/or receive user-specific data from the access point 110. In general, each of the selected user terminals 120 may include a number (Nᵤₜ) of antennas. In some aspects, at least some of the selected user terminals 120 may have different numbers of antennas.

The wireless system 100 may be a time division duplex (TDD) system or a frequency division duplex (FDD) system. For a TDD system, downlink and uplink communications may operate on the same frequency band. For an FDD system, downlink and uplink communications may operate on different frequency bands. In some aspects, the wireless system 100 may utilize a single carrier or multiple carriers for transmission. In other aspects, the wireless system 100 may implement TDMA signaling techniques.

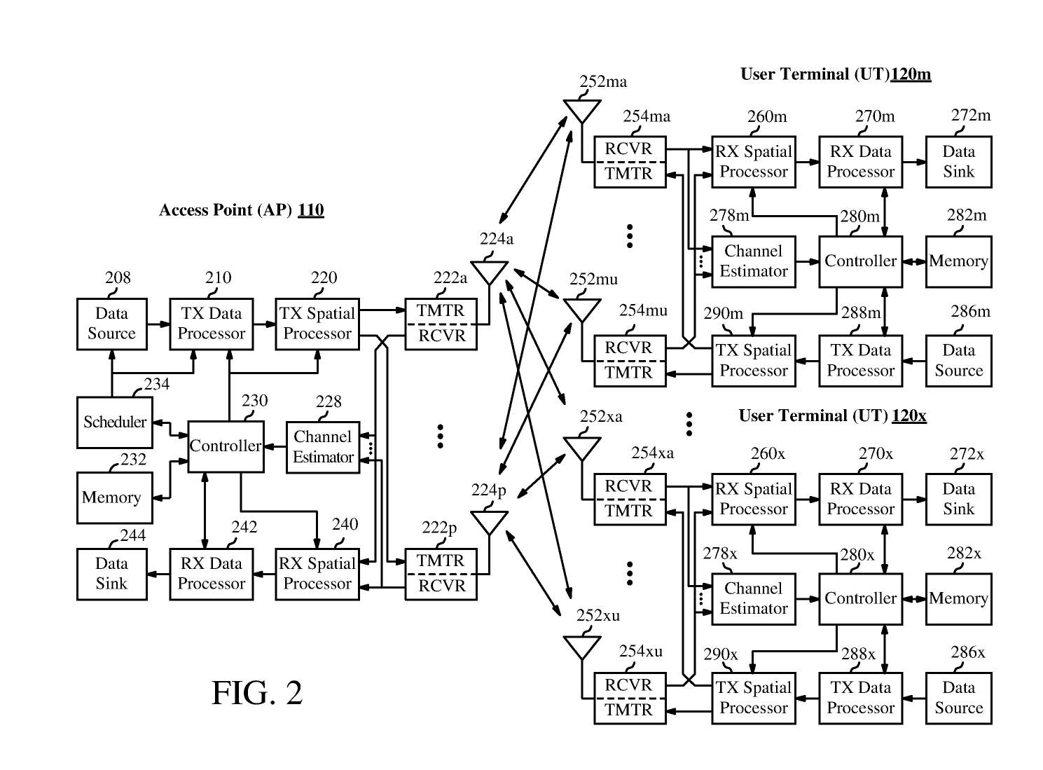

FIG. 2 shows the access point 110, a first user terminal 120 m, and a second user terminal 120 x of the wireless system 100 of FIG. 1. The access point 110 includes a number (Nₐₚ) of antennas 224a through 224ap. The first user terminal 120m includes a number (N_{ut,m}) of antennas 252ₘₐ through 252ₘᵤ, and the second user terminal 120x includes a number (N_{ut,x}) of antennas 252ₓₐ through 252ₓᵤ. The access point 110 may be a transmitting entity for downlink communications, and may be a receiving entity for uplink communications. The user terminals 120 may be a transmitting entity for uplink communications, and may be a receiving entity for downlink communications. As used herein, a “transmitting entity” may refer to an apparatus or device capable of transmitting data via a wireless channel, and a “receiving entity” may refer to an apparatus or device capable of receiving data via a wireless channel In the following description, the subscript “dn” denotes the downlink channel, and the subscript “up” denotes the uplink channel. For example, a number (Nᵤₚ) of user terminals 120 may be selected for simultaneous transmission on the uplink channel, and a number (N_{dn}) of user terminals 120 may be selected for simultaneous transmission on the downlink channel The number of user terminals 120 selected for uplink transmissions may or may not be equal to the number of user terminals 120 selected for downlink transmissions. In some aspects, the access point 110 and/or the user terminals 120 may use beam-steering and/or other spatial processing techniques to communicate wireless signals with each other (and/or other wireless devices, not shown in FIG. 2 for simplicity).

Each of the user terminals 120 selected for uplink transmissions includes a TX data processor 288 that receives traffic data from a data source 286 and receives control data from a controller 280. For example, in the first user terminal 120 m, the TX data processor 288 processes (e.g., encodes, interleaves, and modulates) traffic data based on the selected coding and modulation schemes, and generates a stream of data symbols. A TX spatial processor 290 performs spatial processing to convert the data symbol stream to a number (N_{ut,m}) of transmit symbol streams to be transmitted via the N_{ut,m} antennas. The first user terminal 120m includes a number of transceiver units 254ma-254mu, each of which includes a transmitter portion “TMTR” and a receiver portion “RCVR.” Each of the transceiver units 254ma-254mu receives and processes (e.g., converts to analog, amplifies, filters, and frequency up-converts) a respective transmit symbol stream to generate an uplink signal, which in turn may be output for transmission via the antennas 252ma-252mu of the first user terminal 120m. Similarly, the second user terminal 120x includes a number of transceiver units 254xa-254xu, each of which includes a transmitter portion “TMTR” and a receiver portion “RCVR.” Each of the transceiver units 254xa-254xu receives and processes (e.g., converts to analog, amplifies, filters, and frequency up-converts) a respective transmit symbol stream to generate an uplink signal, which in turn may be output for transmission via the antennas 252xa-252xu of the second user terminal 120x.

As described above, the user terminals 120 may be scheduled for simultaneous uplink transmissions. Each of the user terminals 120 may perform spatial processing on its respective data symbol stream and transmit its respective set of transmit symbol streams, via an uplink channel, to the access point 110.

At the access point 110, antennas 224a-224p may receive the uplink signals from the user terminals 120. Each of the antennas 224a-224p provides a received signal to a respective one of a number of transceiver units 222a-222p. Each of the transceiver units 222a-222p includes a transmitter portion “TMTR” and a receiver portion “RCVR,” and performs processing complementary to that performed by transmitter portions of the transceiver units 254ma-254mu of the first user terminal 120m and/or by transmitter portions of the transceiver units 254xa-254xu of the second user terminal 120x. An RX spatial processor 240 performs receiver spatial processing on the received symbol streams from the receiver portions of transceiver units 222a-222p to generate uplink data symbol streams. The receiver spatial processing may be performed in accordance with a channel correlation matrix inversion (CCMI), a minimum mean square error (MMSE), a soft interference cancellation (SIC), or other suitable technique. Each recovered uplink data symbol stream may be an estimate of a data symbol stream transmitted by a respective one of user terminals 120. An RX data processor 242 processes (e.g., demodulates, de-interleaves, and decodes) each recovered uplink data symbol stream based on the modulation and coding scheme used for that stream to obtain decoded data. The decoded data for each of the user terminals 120 may be provided to a data sink 244 for storage and/or a controller 230 for further processing.

The access point 110 also includes a TX data processor 210 to receive data from a data source 208, to receive control data from a controller 230, and/or to receive additional data from a scheduler 234. The various types of data may be sent on different transport channels. TX data processor 210 processes (e.g., encodes, interleaves, and modulates) the data for each of the user terminals 120 based on the modulation and coding scheme selected for that user terminal 120. The TX data processor 210 may provide a respective downlink data symbol stream for each of the user terminals 120. A TX spatial processor 220 performs spatial processing (such as a precoding or beamforming) to convert the downlink data symbol streams to a number (N_{dn}) of transmit symbol streams to be transmitted via the antennas 224a-224p of the access point 110. The transmitter portion of each of the transceiver units 222a-222p receives and processes a respective transmit symbol stream to generate a downlink signal. The transceiver units 222a-222p may provide the downlink signals for transmission via the antennas 224a-224p, for example, to transmit to the user terminals 120.

At each of the user terminals 120, antennas 252ma-252mu and 252xa-252xu may receive the downlink signals from the access point 110. Each of the transceiver units 254ma-254mu in the first user terminal 120m processes a received signal from an associated one of antennas 252ma-252mu to recover a received symbol stream, and each of the transceiver units 254xa-254xu in the second user terminal 120x processes a received signal from an associated one of antennas 252xa-252xu to recover a received symbol stream. An RX spatial processor 260 within each of the user terminals 120 performs receiver spatial processing on the received symbol streams to generate a downlink data symbol stream. The receiver spatial processing may be performed in accordance with the CCMI, MMSE, or other suitable technique. An RX data processor 270 within each of the user terminals 120 processes (e.g., demodulates, de-interleaves and decodes) the recovered downlink data symbol stream to obtain decoded data.

A channel estimator 278 within each of the user terminals 120 may estimate the downlink channel response, and may provide downlink channel estimates (e.g., which may include channel gain estimates, SNR estimates, noise variance, and so on). Similarly, a channel estimator 228 within the access point 110 may estimate the uplink channel response, and may provide uplink channel estimates. A controller 280 within each of the user terminals 120 may derive the spatial filter matrix for the respective one of the user terminals 120 based on the downlink channel response matrix H_{dn,m} for the respective one of the user terminals 120. The controllers 280 may send feedback information (e.g., the downlink and/or uplink eigenvectors, eigenvalues, SNR estimates, and so on) to the access point 110. A controller 230 may derive the spatial filter matrix for the access point 110 based on the effective uplink channel response matrix H_{up,eff}. In addition, the operation of various processing units within the access point 110 may be controlled and/or coordinated by controller 230, and the operation of various processing units within each of the user terminals 120 may be controlled and/or coordinated by a corresponding controller 280.

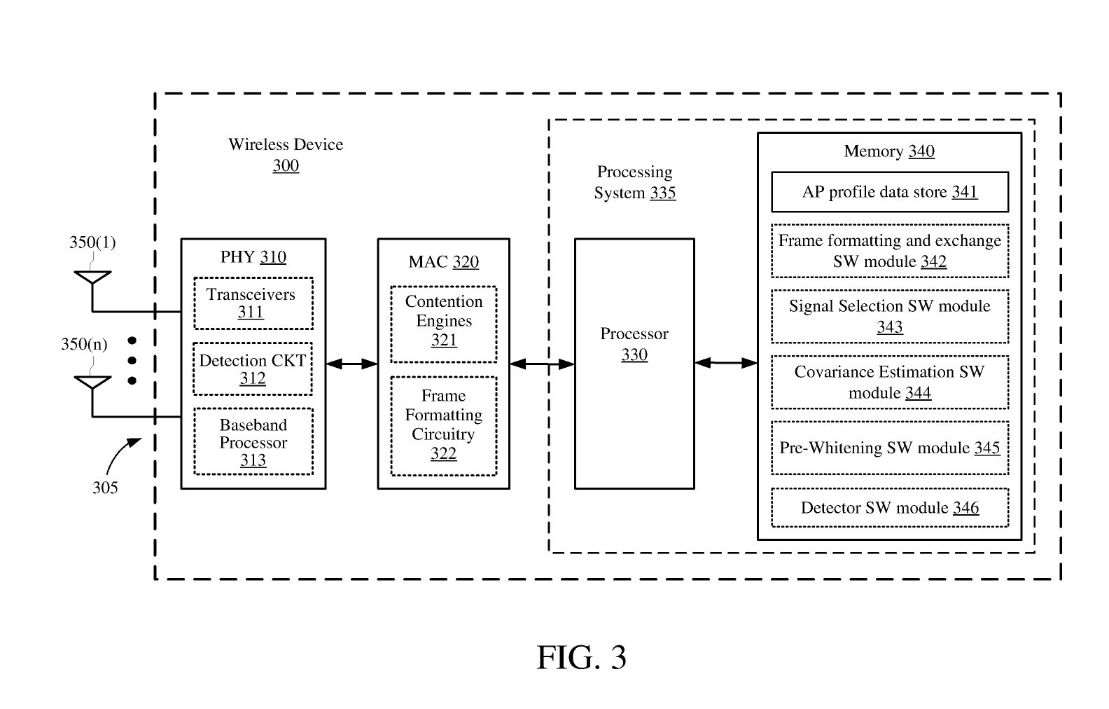

FIG. 3 shows an example wireless device 300 that may be one implementation of one or more of the user terminals 120 of FIGS. 1-2 (or an implementation of a STA). The wireless device 300 may include a physical-layer device (PHY) 310, a medium access controller (MAC) 320, a processor 330, a memory 340, and a number of antennas 350 (1)-350(n). The PHY 310 may include at least a number of transceivers 311, a detection circuit 312, and a baseband processor 313. The transceivers 311 may be coupled to antennas 350(1)-350(n), either directly or through an antenna selection circuit (not shown for simplicity). The transceivers 311 may be used to transmit signals to and receive signals from access point 110 and/or other wireless devices such as STAs/UTs (see also FIG. 1), and may be used to scan the surrounding environment to detect and identify nearby access points and/or other wireless devices (e.g., within wireless range of wireless device 300). Although not shown in FIG. 3 for simplicity, the transceivers 311 may include any number of transmit chains to process and transmit signals to other wireless devices via antennas 350(1)-350(n), and may include any number of receive chains to process signals received from antennas 350(1)-350(n). Thus, for at least some implementations, the wireless device 300 may be configured for MIMO operations. The MIMO operations may include SU-MIMO operations and MU-MIMO operations.

For some implementations, the antennas 350(1)-350(n) and one or more components of PHY 310 (e.g., transceivers 311) may form or be part of an interface 305 configured to receive or obtain wireless signals transmitted from one or more other devices. In some aspects, wireless device 300 may operate in a wireless network that supports MU-MIMO communications, and interface 305 may be configured to receive or obtain a plurality of spatial streams containing data for multiple users. For example, the spatial streams may include a first signal containing data intended for wireless device 300 and include a number of second signals containing data intended for one or more other devices. The interface 305 may also be configured to transmit MU-MIMO communications to one or more other devices (e.g., via a plurality of spatial streams).

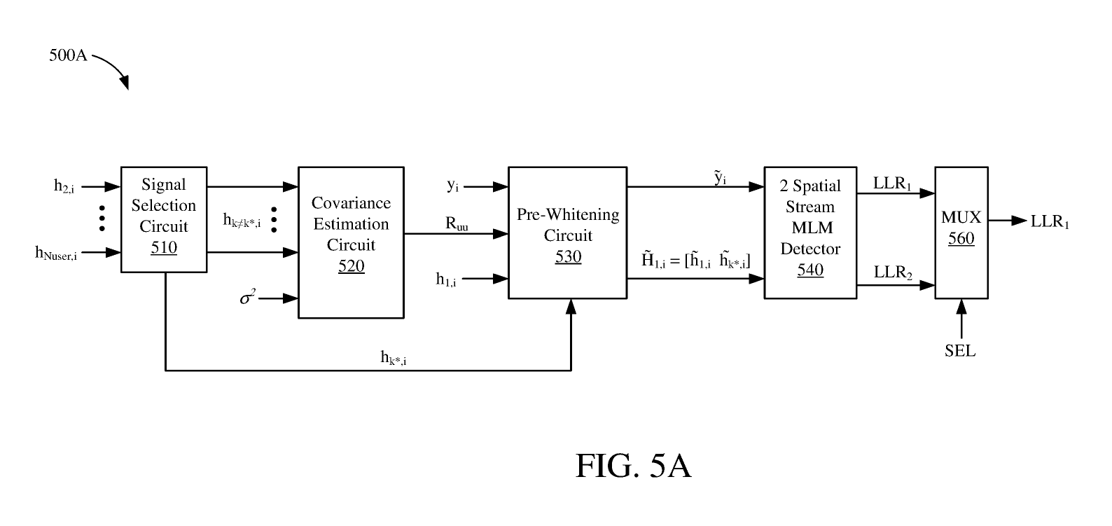

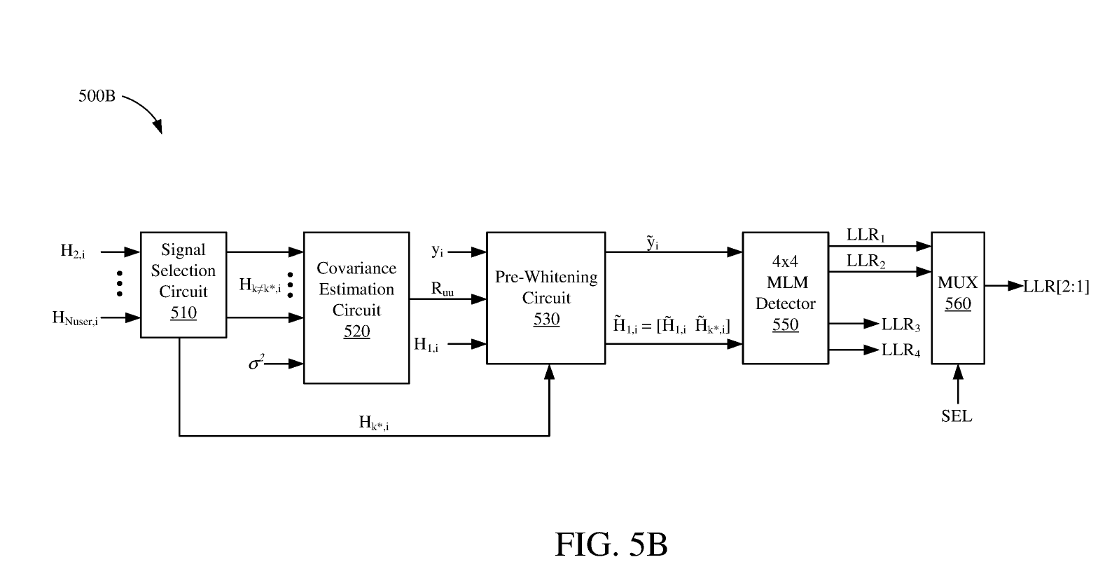

The detection circuit 312 may be used to detect a wireless signal received by the wireless device 300. More specifically, the detection circuit 312 may be used to distinguish between spatial streams containing data intended for wireless device 300 and spatial streams containing data intended for other devices, for example, as described in more detail below with respect to FIGS. 5A-5B, 6, and 7A-7B. Further, although the example of FIG. 3 depicts the detection circuit 312 as external to transceivers 311, for some implementations, the detection circuit 312 may be included within transceivers 311 (e.g., coupled to and/or embedded within the receive chains of transceivers 311). For other implementations, the detection circuit 312 may be separate from PHY 310.

The baseband processor 313 may be used to process signals received from processor 330 and/or memory 340 and to forward the processed signals to transceivers 311 for transmission via one or more of antennas 350(1)-350(n), and may be used to process signals received from one or more of antennas 350(1)-350(n) via transceivers 311 and to forward the processed signals to processor 330 and/or memory 340.

The MAC 320 may include at least a number of contention engines 321 and frame formatting circuitry 322. The contention engines 321 may contend for access to one more shared wireless mediums, and may also store packets for transmission over the one more shared wireless mediums. The wireless device 300 may include one or more contention engines 321 for each of a plurality of different access categories. For other implementations, the contention engines 321 may be separate from MAC 320. For still other implementations, the contention engines 321 may be implemented as one or more software modules (e.g., stored in memory 340 or stored in memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY 310 (e.g., by stripping MAC headers from frames received from PHY 310).

For purposes of discussion herein, MAC 320 is shown in FIG. 3 as being coupled between PHY 310 and processor 330. For actual implementations, PHY 310, MAC 320, processor 330, and/or memory 340 may be connected together using one or more buses (not shown for simplicity). Processor 330, which may also be referred to as a central processing unit (CPU), may perform logical and arithmetic operations based on program instructions stored within the memory 340.

Memory 340 may include an AP profile data store 341 that stores profile information for a plurality of APs. The profile information for a particular AP may include information including, for example, the AP's service set identification (SSID), MAC address, channel information, received signal strength indicator (RSSI) values, goodput values, channel state information (CSI), supported data rates, connection history with the AP, a trustworthiness value of the AP (e.g., indicating a level of confidence about the AP's location, etc.), and any other suitable information pertaining to or describing the operation of the AP.

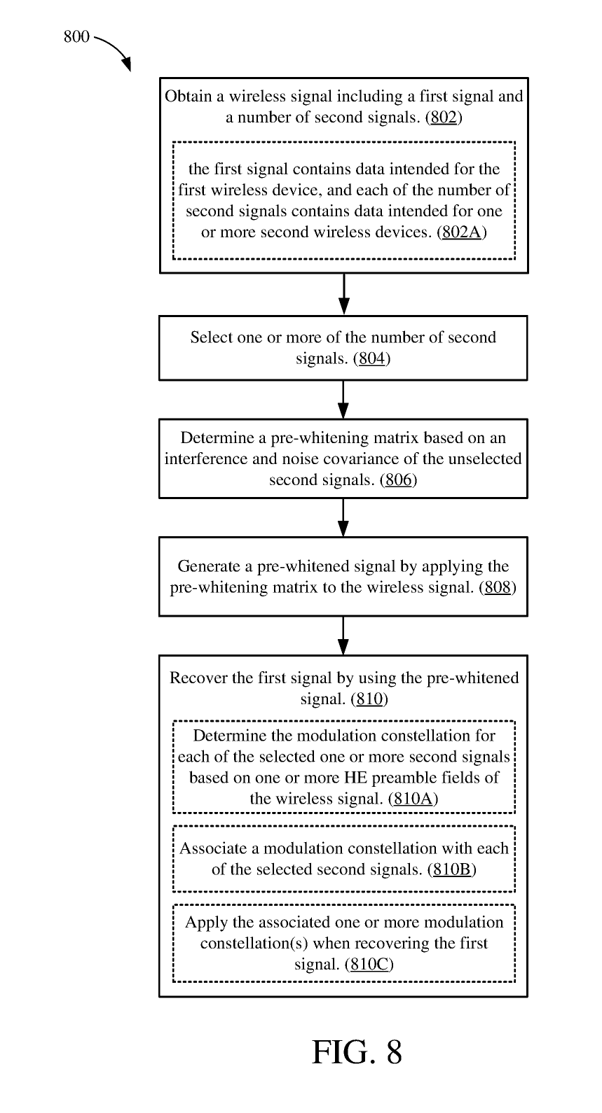

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (e.g., data frames, action frames, control frames, and management frames) used in communications between wireless device 300 and other wireless devices (e.g., as described below for one or more operations of FIG. 8);
a signal selection software module 343 to facilitate the selection of interfering signals for exclusion from pre-whitening matrix determinations (e.g., as described below for one or more operations of FIG. 8);
a covariance estimation software module 344 to facilitate the calculation of interference and noise covariance for received signals in the absence of the selected interfering signals (e.g., as described below for one or more operations of FIG. 8);
a pre-whitening software module 345 to facilitate the determination and implementation of pre-whitening operations for received signals (e.g., as described below for one or more operations of FIG. 8); and
a detector software module 346 to facilitate the recovery of one or more signals containing data intended for reception by the wireless device 300 (e.g., as described below for one or more operations of FIG. 8). Each software module includes instructions that, when executed by processor 330, cause the wireless device 300 to perform the corresponding functions. The non-transitory computer-readable medium of memory 340 thus includes instructions for performing all or a portion of the operations depicted in FIG. 8.

Processor 330 may be any suitable one or more processors capable of executing scripts or instructions of one or more software programs stored in wireless device 300 (e.g., within memory 340). In some aspects, processor 330 and the instructions associated with programs stored in memory 340 (as well as the memory 340 itself) may be collectively referred to herein as a processing system 335. Processor 330 may execute the frame formatting and exchange software module 342 to facilitate the creation and exchange of any suitable frames (e.g., data frames, action frames, control frames, and management frames) used in communications between wireless device 300 and other wireless devices. Processor 330 may execute the signal selection software module 343 to facilitate the selection of interfering signals for exclusion from pre-whitening matrix determinations. Processor 330 may execute the covariance estimation software module 344 to facilitate the calculation of interference and noise covariance for received signals in the absence of the selected interfering signals. Processor 330 may execute the pre-whitening software module 345 to facilitate the determination and implementation of pre-whitening operations for received signals. Processor 330 may execute the detector software module 346 to facilitate the recovery of one or more signals containing data intended for reception by the wireless device 300.

In some cases, rather than actually transmitting a frame, the wireless device 300 may include an interface (e.g., interface 305) to output a frame for transmission. For example, a processor (e.g., processor 330) may output a frame, via a bus interface, to a radio frequency (RF) front end for transmission. Similarly, rather than actually receiving a frame, the wireless device 300 may include an interface (e.g., interface 305) to obtain a frame received from another device. For example, a processor (e.g., processor 330) may obtain (or receive) a frame, via a bus interface, from an RF front end for reception. In some aspects, the RF front end may correspond to one or more components of PHY 310.

For some implementations, the wireless device 300 may operate as a wireless node. For example, the wireless node may include a receiver (e.g., within or associated with transceiver 311) to receive or obtain a wireless signal including a first signal and a number of second signals. The wireless node may also include a processing system (e.g., processing system 335) configured to select one or more of the number of second signals and then determine a pre-whitening matrix based on an interference and noise covariance of the unselected second signals. The processing system may also be configured to generate a pre-whitened signal by applying the pre-whitening matrix to the wireless signal, and recover the first signal by using the pre-whitened signal.

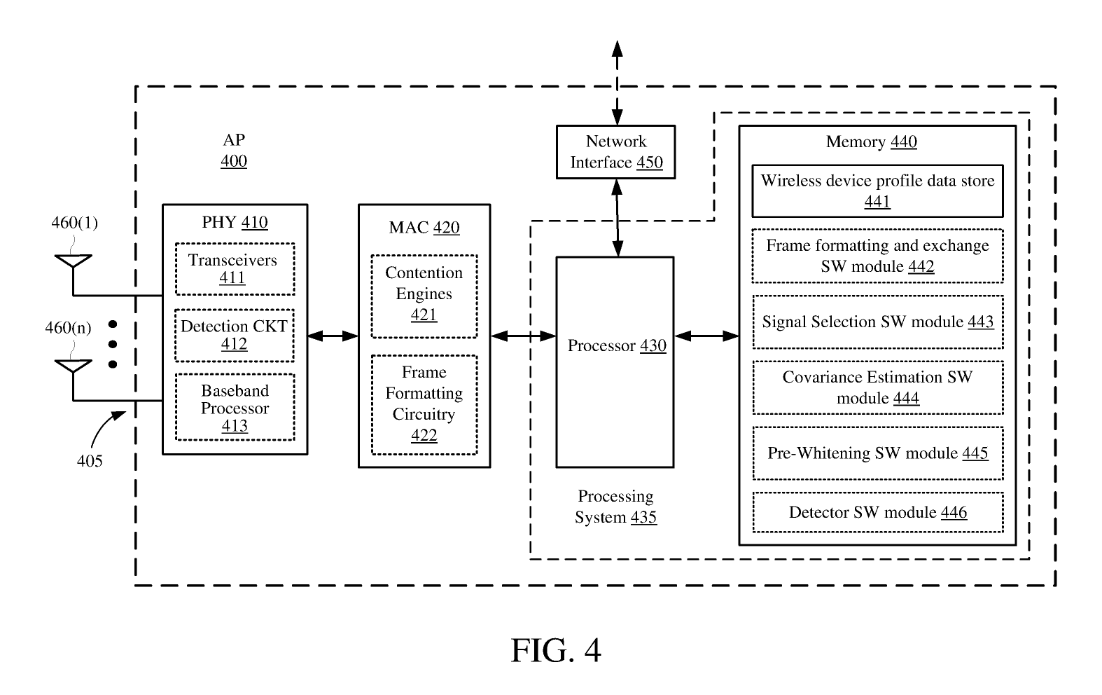

FIG. 4 shows an example access point 400 that may be one implementation of the access points 110 of FIGS. 1-2. The AP 400 may include a PHY 410, a MAC 420, a processor 430, a memory 440, a network interface 450, and a number of antennas 460(1)-460(n). The PHY 410 may include at least a number of transceivers 411, a detection circuit 412, and a baseband processor 413. The transceivers 411 may be coupled to antennas 460(1)-460(n), either directly or through an antenna selection circuit (not shown for simplicity). The transceivers 411 may be used to communicate wirelessly with one or more STAs/UTs, with one or more other APs, and/or with other suitable devices. Although not shown in FIG. 4 for simplicity, the transceivers 411 may include any number of transmit chains to process and transmit signals to other wireless devices via antennas 460(1)-460(n), and may include any number of receive chains to process signals received from antennas 460(1)-460(n). Thus, for at least some implementations, the AP 400 may be configured for MIMO operations including, for example, SU-MIMO operations and MU-MIMO operations.

For some implementations, the antennas 460(1)-460(n) and one or more components of PHY 410 (e.g., transceivers 411) may form or be part of an interface 405 configured to transmit a plurality of spatial streams containing data for one or more users. For example, when operating in a wireless network that supports MU-MIMO communications, the interface 405 may be configured to transmit a different set of spatial streams to each of a number of other devices. When operating in a wireless network that supports SU-MIMO communications, the interface 405 may be configured to transmit a plurality of spatial streams to another user or device. The interface 405 may also be configured to receive or obtain SU-MIMO and/or MU-MIMO communications from one or more other devices (e.g., via a plurality of spatial streams).

The detection circuit 412 may be used to detect a wireless signal received by the AP 400. More specifically, the detection circuit 412 may be used to distinguish between spatial streams containing data intended for AP 400 and spatial streams containing data intended for other devices, for example, as described in more detail below with respect to FIGS. 5A-5B, 6, and 7A-7B. Further, although the example of FIG. 4 depicts the detection circuit 412 as external to transceivers 411, for some implementations, the detection circuit 412 may be included within transceivers 411 (e.g., coupled to and/or embedded within the receive chains of transceivers 411). For other implementations, the detection circuit 412 may be separate from PHY 410.

The baseband processor 413 may be used to process signals received from processor 430 and/or memory 440 and to forward the processed signals to transceivers 411 for transmission via one or more of antennas 460(1)-460(n), and may be used to process signals received from one or more of antennas 460(1)-460(n) via transceivers 411 and to forward the processed signals to processor 430 and/or memory 440.

The network interface 450 may be used to communicate with a WLAN server (not shown for simplicity) either directly or via one or more intervening networks and to transmit signals.

The MAC 420 includes at least a number of contention engines 421 and frame formatting circuitry 422. The contention engines 421 may contend for access to the shared wireless medium, and may also store packets for transmission over the shared wireless medium. For some implementations, AP 400 may include one or more contention engines 421 for each of a plurality of different access categories. For other implementations, the contention engines 421 may be separate from MAC 420. For still other implementations, the contention engines 421 may be implemented as one or more software modules (e.g., stored in memory 440 or within memory provided within MAC 420) containing instructions that, when executed by processor 430, perform the functions of contention engines 421.

The frame formatting circuitry 422 may be used to create and/or format frames received from processor 430 and/or memory 440 (e.g., by adding MAC headers to PDUs provided by processor 430), and may be used to re-format frames received from PHY 410 (e.g., by stripping MAC headers from frames received from PHY 410).

For purposes of discussion herein, MAC 420 is shown in FIG. 4 as being coupled between PHY 410 and processor 430. For actual implementations, PHY 410, MAC 420, processor 430, memory 440, and/or network interface 450 may be connected together using one or more buses (not shown for simplicity). Processor 430, which may also be referred to as a central processing unit (CPU), may perform logical and arithmetic operations based on program instructions stored within the memory 440.

Memory 440 may include a wireless device profile data store 441 that stores profile information for a plurality of wireless devices (e.g., STAs, UTs, and/or other suitable devices). The profile information for a particular wireless device may include information including, for example, its MAC address, supported data rates, connection history with AP 400, and any other suitable information pertaining to or describing the operation of the wireless device.

Memory 440 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 442 to facilitate the creation and exchange of any suitable frames (e.g., data frames, action frames, control frames, and management frames) used in communications between AP 400 and other wireless devices (e.g., as described below for one or more operations of FIG. 8);
a signal selection software module 443 to facilitate the selection of interfering signals for exclusion from pre-whitening matrix determinations (e.g., as described below for one or more operations of FIG. 8);
a covariance estimation software module 444 to facilitate the calculation of interference and noise covariance for received signals in the absence of the selected interfering signals (e.g., as described below for one or more operations of FIG. 8);
a pre-whitening software module 445 to facilitate the determination and implementation of pre-whitening operations for received signals (e.g., as described below for one or more operations of FIG. 8); and
a detector software module 446 to facilitate the recovery of one or more signals containing data intended for reception by the AP 400 (e.g., as described below for one or more operations of FIG. 8).
   Each software module includes instructions that, when executed by processor 430, cause AP 400 to perform the corresponding functions. The non-transitory computer-readable medium of memory 440 thus includes instructions for performing all or a portion of the operations depicted in FIG. 8.

Processor 430 may be any suitable one or more processors capable of executing scripts or instructions of one or more software programs stored in AP 400 (e.g., within memory 440). In some aspects, processor 430 and the instructions associated with programs stored in memory 440 (as well as memory 440 itself) may be collectively referred to herein as a processing system 435. Processor 430 may execute the frame formatting and exchange software module 442 to facilitate the creation and exchange of any suitable frames (e.g., data frames, action frames, control frames, and management frames) used in communications between AP 400 and other wireless devices. Processor 430 may execute the signal selection software module 443 to facilitate the selection of interfering signals for exclusion from pre-whitening matrix determinations. Processor 430 may execute the covariance estimation software module 444 to facilitate the calculation of interference and noise covariance for received signals in the absence of the selected interfering signals. Processor 430 may execute the pre-whitening software module 445 to facilitate the determination and implementation of pre-whitening operations for received signals. Processor 430 may execute the detector software module 446 to facilitate the recovery of one or more signals containing data intended for reception by the AP 400.

In some cases, rather than actually transmitting a frame, the AP 400 may include an interface (e.g., interface 405) to output a frame for transmission. For example, a processor (e.g., processor 430) may output a frame, via a bus interface, to a radio frequency (RF) front end for transmission. Similarly, rather than actually receiving a frame, the AP 400 may include an interface (e.g., interface 405) to obtain a frame received from another device. For example, a processor (e.g., processor 430) may obtain (or receive) a frame, via a bus interface, from an RF front end for reception. In some aspects, the RF front end may correspond to one or more components of PHY 410.

For some implementations, the AP 400 may operate as a wireless node. For example, the wireless node may include a receiver (e.g., within or associated with transceiver 411) to receive or obtain a wireless signal including a first signal and a number of second signals. The wireless node may also include a processing system (e.g., processing system 435) configured to select one or more of the number of second signals and determine a pre-whitening matrix based on an interference and noise covariance of the unselected second signals. The processing system (e.g., processing system 435) may also be configured to generate a pre-whitened signal by applying the pre-whitening matrix to the wireless signal, and recover the first signal by using the pre-whitened signal.

As described above, in DL MU-MIMO communications, an AP may transmit data to multiple users using the same time and frequency resources. Each user may receive signals containing data intended for that user, may receive signals containing data intended for other users, and may receive noise and/or interference. Conventional receivers may treat signals containing data intended for other users as noise (e.g., as additional white noise). For example, a conventional receiver may employ a minimum mean-squared error interference suppression (MMSE-IS) spatial filter that separates a received signal into independent spatial streams that may be detected by a corresponding number of single-input single-output (SISO) demappers. Each of the SISO demappers may generate a corresponding stream of log-likelihood ratios (LLRs). The LLR streams may be processed by a de-interleaver and a channel decoder to isolate the signal containing data intended for the user. Although treating signals containing data intended for other users as additional white noise may allow MMSE-IS spatial filter-based receivers to be used for MU-MIMO communications, these receivers may not consider the known structure and/or signal characteristics of the interfering signals, which in turn may limit the efficiency of such receivers.

In accordance with aspects of the present disclosure, a wireless device may include a receiver configured to analyze the structure and/or signal characteristics of the interfering signals to more effectively distinguish between signals (spatial streams) intended for the wireless device and signals (spatial streams) intended for other wireless devices. More specifically, the receiver may receive a MIMO transmission including a first signal (or first spatial streams) containing data intended for the wireless device and including a number of second signals (or second spatial streams) containing data intended for other wireless devices. In some aspects, the receiver may analyze the received MIMO transmission to determine a pre-whitening matrix to be applied to the received MIMO transmission. Because the structure and/or signal characteristics of the second signals (e.g., the interfering signals) may be known to the receiver, applying the determined pre-whitening matrix to the received MIMO transmission may improve the receiver's ability to distinguish between the first signals and the second signals (e.g., as compared with conventional MMSE-IS spatial filter-based receivers).

For some implementations, one or more interfering users may be selected for exclusion from determination of the pre-whitening matrix, for example, to increase the effectiveness of the pre-whitening matrix. In some aspects, the one or more interfering signals may be selected by determining which of the interfering signals has an amount of energy spillover, into a channel of interest, that exceeds a threshold value. The channel of interest may be the wireless channel upon which the first signal is transmitted. The receiver may detect the first signal from the MIMO transmission by determining the pre-whitening matrix based on the unselected second signals, and then applying the determined pre-whitening matrix to the received MIMO transmissions.

FIG. 5A shows a detection circuit 500A in accordance with aspects of the present disclosure. The detection circuit 500A may be implemented within a receiver of any suitable wireless device (e.g., within the access point (AP) 110 of FIGS. 1-2, the user terminals 120 of FIGS. 1-2, the wireless device 300 of FIG. 3, and/or the AP 400 of FIG. 4). In some aspects, the detection circuit 500A may be one implementation of the detection circuit 312 of FIG. 3 and/or one implementation of the detection circuit 412 of FIG. 4. In other aspects, the functions performed by the detection circuit 500A may be implemented by executing one or more of the software programs or instructions stored in memory 340 of FIG. 3 (e.g., by processor 330) and/or may be implemented by executing one or more of the software programs or instructions stored in memory 440 of FIG. 4 (e.g., by processor 430).

The detection circuit 500A is shown to include a signal selection circuit 510, a covariance estimation circuit 520, a pre-whitening circuit 530, a 2-spatial stream maximum-Log-MAP (MLM) detector 540, and a multiplexer (MUX) 560. As discussed in more detail below, the detection circuit 500A of FIG. 5A may be employed in a receiving device when the modulation constellation used by a transmitting device is known to the receiving device.

For purposes of discussion herein, a signal vector received by an MU-MIMO receiver on an i^{th} tone may be expressed as follows:

yᵢ=Hᵢxᵢ+nᵢ, for i=1, 2, 3, . . . Nₜₒₙₑₛ

Hᵢ=[H_{1,i} H_{2,i} . . . H_{N}_{ᵤₛₑᵣ}_{,i}]

xᵢ=[x_{1,i}^{T} x_{2,i}^{T} . . . x_{N}_{ᵤₛₑᵣ}_{,i}]^{T}, where:

H_{k,i} has size Nᵣ by Nₛₛ for k=1, 2, . . . , Nᵤₛₑᵣ, xᵢ has size NₛₛNᵤₛₑᵣ by 1, Nₛₛ is the number of spatial streams transmitted to each user, Nᵤₛₑᵣ is the number of co-scheduled users, and Nᵣ is the number of receiving antennas for each user. For the example of FIG. 5A, a received wireless signal may be expressed as:

$${y}_{i} = {h}_{1 , i} {x}_{1 , i} + {h}_{{k}^{*} , i} {x}_{{k}^{*} , i} + {\sum }_{k = 2 , k \neq {k}^{*}}^{{N}_{user}} {h}_{k , i} {x}_{k , i} + {n}_{i}$$

The signal selection circuit 510 may select one of the interfering signals for exclusion from a determination of the pre-whitening matrix. In some aspects, the signal selection circuit 510 may analyze the channel frequency responses h_{k,i} for k≠i signals (or users), and then select a k*^{th} signal for exclusion from the other interfering signals when determining the pre-whitening matrix. In other aspects, the signal selection circuit 510 may select more than one interfering signal for exclusion from determination of the pre-whitening matrix.

After selection of the k*^{th} signal for exclusion from determination of the pre-whitening matrix, the selected signal's channel frequency response hₖ*_{,i} may be provided to the pre-whitening circuit 530, and the other channel frequency responses h_{k,i} for k≠i and k≠k* (e.g., corresponding to the unselected interfering signals) may be provided to the covariance estimation circuit 520. In this manner, the interfering signal selected for exclusion from determination of the pre-whitening matrix may bypass the covariance estimation circuit 520. The noise variance σ² may also be provided to the covariance estimation circuit 520. The covariance estimation circuit 520 may determine the covariance of the interference and noise matrix Rᵤᵤ for the unselected interfering signals, for example, as follows:

$${R}_{uu} = {\sum }_{{k = 1 ,}_{k \neq i , k \neq {k}^{*}}}^{{N}_{user}} {E}_{{x}_{k}} {h}_{k , i} {h}_{k , i}^{H} + {σ}^{2} {I}_{{N}_{r}}$$

where Eₓ_{ₖ} is the expected value of |xₖ|², and I_{N}_{ᵣ} is the identity matrix of size Nᵣ.

After determining the interference and noise covariance, the pre-whitening matrix Rᵤᵤ^{1/2} may be computed using known techniques (such as QR decomposition or Cholesky factorization) together with forward/backward substitution. The pre-whitening circuit 530 may apply the computed pre-whitening matrix to the received signal, for example, as expressed below:

$${\tilde{y}}_{i} = {R}_{uu}^{- 1 / 2} {y}_{i} = {\tilde{h}}_{1 , i} {x}_{1 , i} + {\tilde{h}}_{{k}^{*} , i} {x}_{{k}^{*} , i} + {\tilde{n}}_{i} , where$$

$${\tilde{h}}_{1 , i} = {R}_{uu}^{- 1 / 2} {h}_{1 , i}$$

$${\tilde{h}}_{{k}^{*} , i} = {R}_{uu}^{- 1 / 2} {h}_{{k}^{*} , i} , and$$

$${\tilde{n}}_{i} = {R}_{uu}^{- 1 / 2} ( {\sum }_{{k = 2 ,}_{k \neq {k}^{*}}}^{{N}_{user}} {h}_{k , i} {x}_{k , i} + {n}_{i} )$$

Note that expected value of the pre-whitened noise may be expressed as:

E[ñᵢñᵢ^{T}]=I_{N}_{ᵣ}.

The pre-whitened received signal \tilde{y}ᵢ and the pre-whitened channel response matrix \tilde{H}_{1,i} may be provided to the 2-spatial stream MLM detector 540, which may jointly determine the log likelihood ratio signal (LLR₁) corresponding to the signal intended for the i^{th} user (e.g., the desired user) and the log likelihood ratio signal (LLR₂) corresponding to the signal intended for the k*^{th} user (e.g., the selected interfering user). The LLR₁ and LLR₂ signals are provided to inputs of the MUX 560, which selectively outputs either the LLR₁ signal or the LLR₂ signal based on a select (SEL) signal that identifies the desired user. For the example of FIG. 5A, the SEL signal is driven to a state that causes the MUX 560 to select the LLR₁ signal as the output signal of the detection circuit 500A, for example, because the LLR₁ signal corresponds to the desired user.

FIG. 5B shows another detection circuit 500B in accordance with aspects of the present disclosure. The detection circuit 500B may be implemented within a receiver of any suitable wireless device (e.g., within the access point (AP) 110 of FIGS. 1-2, the user terminals 120 of FIGS. 1-2, the wireless device 300 of FIG. 3, and/or the AP 400 of FIG. 4). In some aspects, the detection circuit 500B may be one implementation of the detection circuit 312 of FIG. 3 and/or one implementation of the detection circuit 412 of FIG. 4. In other aspects, the functions performed by the detection circuit 500B may be implemented by executing one or more of the software programs or instructions stored in memory 340 of FIG. 3 (e.g., by processor 330) and/or may be implemented by executing one or more of the software programs or instructions stored in memory 440 of FIG. 4 (e.g., by processor 430).

The detection circuit 500B may allow for detection of more spatial streams than the detection circuit 500A of FIG. 5A. The detection circuit 500B is similar to the detection circuit 500A of FIG. 5A, except that the 2 -spatial stream MLM detector 540 of FIG. 5A is replaced by a 4×4 MLM detector 550 for the detection circuit 500B of FIG. 5B. The detection circuit 500B of FIG. 5B may be employed in a receiving device when the modulation constellation used by a transmitting device is known to the receiving device.

For the example detection circuit 500B of FIG. 5B, a received signal vector may be expressed as:

yᵢ=H_{1,i}x_{1,i}+Hₖ*_{,i}xₖ*_{,i}+\tilde{H}ᵢ\tilde{x}ᵢ+nᵢ

where \tilde{H}ᵢ [symbol] [H_{2,i} . . . H_{k≠k}*_{,i} . . . H_{N}_{ᵤₛₑᵣ}_{,i}] and \tilde{x}ᵢ [symbol] [x_{2,i} . . . x_{k≠k}*_{,i} . . . x_{N}_{ᵤₛₑᵣ}_{,i}]^{T}
Applying the pre-whitening matrix to the received signal vector yields:

\tilde{y}ᵢ=Rᵤᵤ^{-1/2}yᵢ=Rᵤᵤ^{-1/2}H_{1,i}x_{1,i}+Rᵤᵤ^{-1/2}Hₖ*_{,i}xₖ*_{,i}+Rᵤᵤ^{-1/2}(\tilde{H}ᵢ\tilde{x}ᵢ+n),

where Rᵤᵤ=\tilde{H}ᵢ\tilde{H}*ᵢ+σ²I_{N}_{ᵣ}.
Thus, the value of may be expressed as:

$$\begin{matrix}\begin{matrix}{\tilde{y}}_{i} = {\tilde{H}}_{1 , i} {x}_{1 , i} + {\tilde{H}}_{{k}^{*} i} {x}_{{k}^{*} , i} + {\tilde{n}}_{i} \\ = {{H}^{\tilde{\sim}}}_{i } {{x}^{\tilde{\sim}}}_{i} + {\tilde{n}}_{i}\end{matrix} & \\ where {{H}^{\tilde{\sim}}}_{i} = [ \begin{matrix}{\tilde{H}}_{1 , i} & {\tilde{H}}_{{k}^{*} , i}\end{matrix} ] , {\tilde{H}}_{1 , i} = {R}_{uu}^{- 1 / 2} {\tilde{H}}_{1 , i} , {\tilde{H}}_{{k}^{*} , i} = {R}_{uu}^{- 1 / 2} {H}_{{k}^{*} , i} , \\ {\tilde{n}}_{i} = {R}_{uu}^{- 1 / 2} ( {\tilde{H}}_{i} {\tilde{x}}_{i} + {n}_{i} ) , E [ {\tilde{n}}_{i} {\tilde{n}}_{i}^{*} ] = {I}_{{N}_{r}} , and {{x}^{\tilde{\sim}}}_{i} = {[ \begin{matrix}{x}_{1 , i} & {x}_{{k}^{*} , i}\end{matrix} ]}^{T} & \end{matrix}$$

The pre-whitened received signal \tilde{y}ᵢ and the pre-whitened channel response matrix \tilde{H}_{1,i} may be provided to the 4×4 MLM detector 550, which may jointly determine the log likelihood ratio signals LLR₁-LLR₂ corresponding to the signal intended for the i^{th} user (e.g., the desired user) and the log likelihood ratio signals LLR₃-LLR₄ corresponding to the signal intended for and the k*^{th} user (e.g., the selected interfering user). The LLR₁-LLR₄ signals are provided to inputs of the MUX 560, which selectively outputs either the LLR₁ and LLR₂ signals or the LLR₃ and LLR₄ signals based on the SEL signal. For the example of FIG. 5B, the SEL signal is driven to a state that causes the MUX 560 to select the LLR₁ and LLR₂ signals to be output from the detection circuit 500B, for example, because the LLR₁ and LLR₂ signals correspond to the desired user. In some aspects, the LLR₃ and LLR₄ signals may not be processed. In other aspects, the LLR₃ and LLR₄ signals may be discarded.

For implementations in which MU-MIMO signals are transmitted using high efficiency (HE) packets formatted in accordance with the IEEE 802.11ax specification, the modulation constellations of the interfering signals may be known to the receiving device. In some aspects, the modulation constellations of the interfering signals may be determined from the preambles of received HE packets. More specifically, for at least some implementations, the modulation constellations of the interfering signals may be indicated by a number of bits provided within the HE-SIG-B field and/or the HE-LTF field of the packet's preamble, for example, as described below with respect to FIG. 10.

For implementations in which MU-MIMO signals are not transmitted using HE packets (e.g., but instead transmitted using packets formatted in accordance with the IEEE 802.11ac standards), the modulation constellations of the interfering signals may not be known to the receiving device. For such implementations, the modulation constellations of received signals may be classified prior to spatial stream detection.

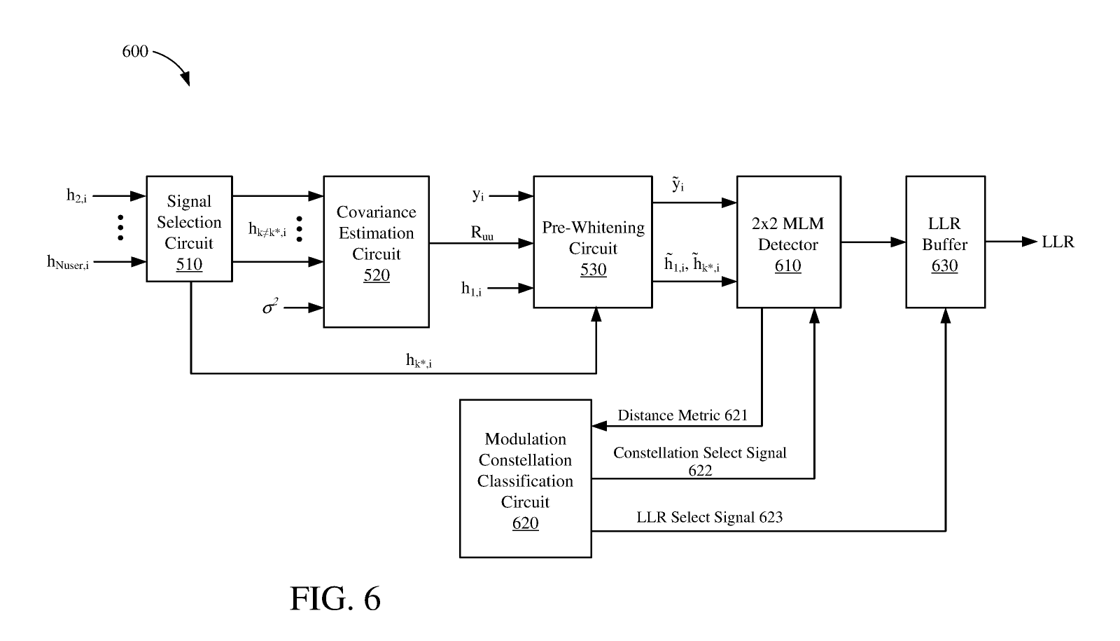

For example, FIG. 6 shows another detection circuit 600 in accordance with aspects of the present disclosure. The detection circuit 600 may be implemented within a receiver of any suitable wireless device (e.g., within the access point 110 of FIGS. 1-2, the user terminals 120 of FIGS. 1-2, the wireless device 300 of FIG. 3, and/or the AP 400 of FIG. 4). In some aspects, the detection circuit 600 may be one implementation of the detection circuit 312 of FIG. 3 and/or one implementation of the detection circuit 412 of FIG. 4. In other aspects, the functions performed by the detection circuit 600 may be implemented by executing one or more of the software programs or instructions stored in memory 340 of FIG. 3 (e.g., by processor 330) and/or may be implemented by executing one or more of the software programs or instructions stored in memory 440 of FIG. 4 (e.g., by processor 430)

The detection circuit 600 is shown to include the signal selection circuit 510, the covariance estimation circuit 520, and the pre-whitening circuit 530 of FIG. 5A, as well as a 2×2 MLM detector 610, a modulation constellation classification circuit 620, and an LLR buffer 630. In some aspects, the 2×2 MLM detector 610, the modulation constellation classification circuit 620, and the LLR buffer 630 may replace the 2-spatial stream MLM detector 540 of FIG. 5A (e.g., when the modulation constellations of interfering signals are unknown). Thus, the detection circuit 600 of FIG. 6 may be employed in a receiving device when the modulation constellation used by a transmitting device is not known to the receiving device.

The 2×2 MLM detector 610 may receive the pre-whitened signal \tilde{y}ᵢ and the pre-whitened channel responses \tilde{h}_{1,i} and \tilde{h}ₖ*_{,i} from the pre-whitening circuit 530. The modulation constellation classification circuit 620 may jointly estimate the other signal's modulation constellation, for example, using a distance metric 621 provided by the 2×2 MLM detector 610 in response to a constellation select signal 623 provided by the modulation constellation classification circuit 620. In some aspects, the modulation constellation classification circuit 620 may determine a best modulation constellation estimate, and then instruct the LLR buffer 630 to output the LLRs corresponding to the best modulation constellation estimate, for example, using an LLR select signal 623. In other aspects, the modulation constellation of the interfering signals may be estimated by decoding one or more preamble fields of the received packet. For example, if the received packet is formatted according to the IEEE 802.11ac standards, then the modulation constellation may be estimated by decoding one or more signaling (SIG) fields of the received packet.

The selection of signals for exclusion from determination of the pre-whitening matrix is an important consideration. More specifically, it is desirable to exclude interfering signals that are well correlated with the signal of interest and/or to exclude interfering signals for which power spillover into the channel of interest equals (or exceeds) a threshold value, for example, because pre-whitening matrices generated using such interfering signals may undesirably suppress the signal of interest, which in turn may reduce the signal to noise ratio (SNR) of the signal of interest at the receiver.

For some implementations, a power metric may be used to select interfering signals for exclusion from pre-whitening matrix determinations. An example power metric may be expressed as:

$${k}^{*} = {max}_{k} ( {\sum }_{i ∈ ( 1 , {N}_{tones} )} {‖ {h}_{k , i } ‖}^{2} ) , k = 2 , 3 , … , {N}_{user}$$

More specifically, the power metric may be used to select the interfering signals having the largest signal power, as seen by the receiver. Alternatively, a power-normalized correlation metric may be used. An example normalized correlation metric may be expressed as:

$${k}^{*} = {max}_{k} ( {\sum }_{i ∈ ( 1 , {N}_{tones} )} \frac{‖ {h}_{1 , i}^{H} {h}_{k , i} ‖}{‖ {h}_{1 , i } ‖ ‖ {h}_{k , i } ‖} ) , k = 2 , 3 , … , {N}_{user}$$

where ∥ ∥ is a normalized matrix/vector.

More specifically, the power-normalized correlation matric may be used to select the interfering signals having a relatively strong correlation with the signal of interest (e.g., the interfering signals for which the correlation with the signal of interest exceeds a threshold value). For other implementations, other suitable metrics may be used to identify or select interfering signals having a large amount of energy spillover into the channel associated with the signal of interest (e.g., an amount of energy spillover that equals or exceeds a threshold value).

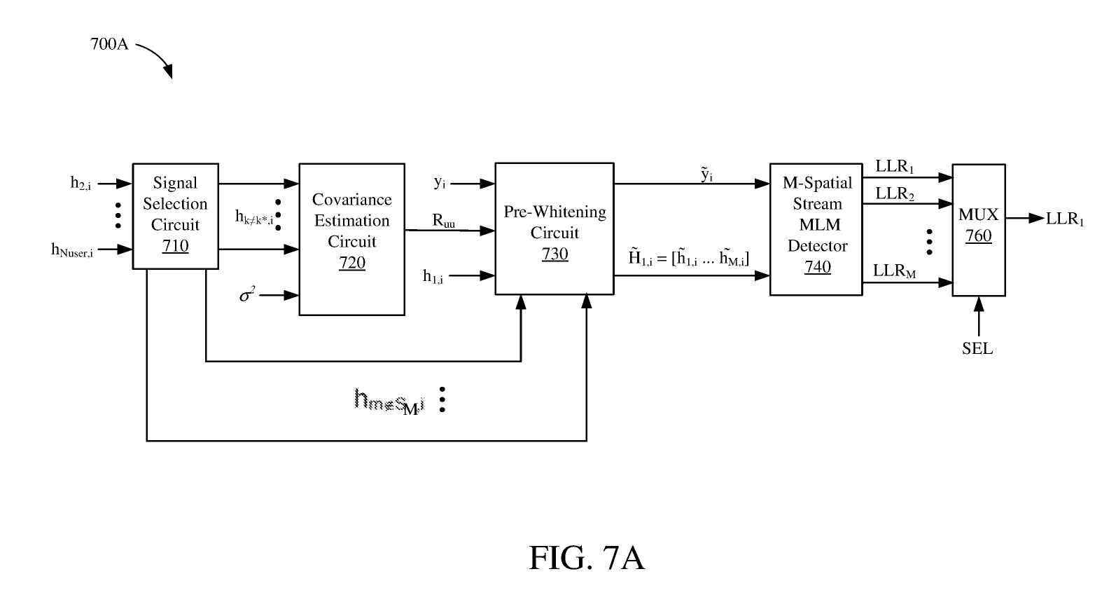

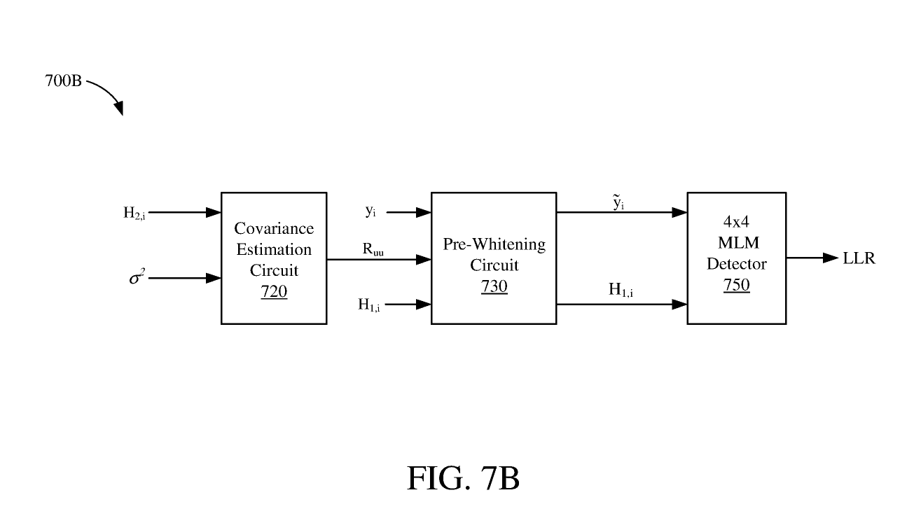

Although the detection circuit 500A and the detection circuit 500B are depicted in FIGS. 5A and 5B as selecting a single interfering signal for exclusion from determining the pre-whitening matrix, various aspects of the present disclosure may allow multiple interfering signals to be selected for exclusion from determining the pre-whitening matrix. For example, FIG. 7A shows another detection circuit 700A in accordance with aspects of the present disclosure. The detection circuit 700A may be implemented within a receiver of any suitable wireless device (e.g., within the access point (AP) 110 of FIGS. 1-2, the user terminals 120 of FIGS. 1-2, the wireless device 300 of FIG. 3, and/or the AP 400 of FIG. 4). In some aspects, the detection circuit 700A may be one implementation of the detection circuit 312 of FIG. 3 and/or one implementation of the detection circuit 412 of FIG. 4. In other aspects, the functions performed by the detection circuit 700A may be implemented by executing one or more of the software programs or instructions stored in memory 340 of FIG. 3 (e.g., by processor 330) and/or may be implemented by executing one or more of the software programs or instructions stored in memory 440 of FIG. 4 (e.g., by processor 430).

The detection circuit 700A is shown to include a signal selection circuit 710, a covariance estimation circuit 720, a pre-whitening circuit 730, an M-spatial stream MLM detector 740, and a MUX 760. The detection circuit 700A may be used for implementations in which the modulation constellations of the interfering signals are known to the receiving device (e.g., when MU-MIMO signals are transmitted using HE packets formatted in accordance with the IEEE 802.11ax specification).

The signal selection circuit 710 may select a set S_{M} of (M−1) interfering signals for exclusion from determination of the pre-whitening matrix. For example, the channel frequency responses h_{k,i} for ≠i may be analyzed, and then the other (M−1) interfering signals may be selected for exclusion. The signal selection circuit 710 may use any suitable metric to select the set S_{M} of interfering signals for exclusion including, for example, a power metric or a power-normalized correlation metric.

After selection of the set S_{M} of interfering signals, the corresponding channel frequency responses h_{k,i} for k∈S_{M}, may be provided to the pre-whitening circuit 730, and the other channel frequency responses h_{k,i} for k∈S_{M} may be provided to the covariance estimation circuit 720. The noise variance σ² may also be provided to the covariance estimation circuit 720. The covariance estimation circuit 720 may determine the covariance of the interference and noise matrix Rᵤᵤ for the unselected interfering signals as follows:

$${R}_{uu} = {\sum }_{k ∉ {S}_{m}} {E}_{{x}_{k}} {h}_{k , i} {h}_{k , i}^{H} + {σ}^{2} {I}_{{N}_{r}}$$

where Eₓ_{ₖ} is the expected value of |xₖ|², and I_{N}_{ᵣ} is the identity matrix of size Nᵣ.

After determining the interference and noise covariance, the pre-whitening matrix Rᵤᵤ^{-1/2} may be computed using known techniques (such as QR decomposition or Cholesky factorization) together with forward/backward substitution. The pre-whitening circuit 730 may apply the computed pre-whitening matrix to the received signal, for example, as expressed below:

$${\tilde{y}}_{i} = {R}_{uu}^{- 1 / 2} {y}_{i} = {\tilde{h}}_{1 , i} {x}_{1 , i} + {\sum }_{m ∈ {S}_{m}} {\tilde{h}}_{m , i} {x}_{m , i} + {\tilde{n}}_{i} , where$$

$${\tilde{h}}_{1 , i} = {R}_{uu}^{- 1 / 2} {h}_{1 , i}$$

$${\tilde{h}}_{m , i} = {R}_{uu}^{- 1 / 2} {h}_{m , i} , for m ∈ {S}_{M} and$$

$${\tilde{n}}_{i} = {R}_{uu}^{- 1 / 2} ( {\sum }_{k ∉ {S}_{m}}^{{N}_{user}} {h}_{k , i} {x}_{k , i} + {n}_{i} )$$

The pre-whitened signal \tilde{y}ᵢ and the pre-whitened channel response matrix \tilde{H}_{1,i} may be provided to the M-spatial stream MLM detector 740, which may jointly determine the log likelihood ratio signal (LLR₁) corresponding to the signal intended for the i^{th} user (e.g., the desired user) and the log likelihood ratio signals (LLR₂-LLR_{M}) corresponding to the signals intended for the set SM of users (e.g., the selected interfering users). The LLR₁-LLR_{M} signals are provided to inputs of the MUX 760, which selectively outputs one of the LLR₁-LLR_{M} signals based on the SEL signal. For the example of FIG. 7A, the SEL signal is driven to a state that causes the MUX 760 to select the LLR₁ signal to be output from the detection circuit 700A, for example, because the LLR₁ signal corresponds to the desired user.

For other implementations in which the modulation constellations of the interfering signals are not known to the receiving device, a set S_{M} of interfering signals may be selected for exclusion from the pre-whitening matrix determination in a manner similar to that described above with respect to FIG. 6 except, for example, that the 2×2 MLM detector 610 may be replaced by a larger MLM detector. For example, when there are 2 users are co-scheduled and each with 4 spatial streams, the system model may be simplified to:

yᵢ=H_{1,i}x_{1,i}+H_{2,i}X_{2,i}+nᵢ

where H_{k,i}, k=1,2 is a Nᵣ×4 and x_{k,i}, k=1,2 is a 4×1 vector, for example, Nᵣ=4 .

In this configuration, the interference and noise covariance may be expressed as:

Rᵤᵤ=H_{2,i}H*_{2,i}+σ²I_{N}_{ᵣ}

The model is pre-whitened by \tilde{y}ᵢ=Rᵤᵤ^{-1/2}yᵢ which results in:

\tilde{y}ᵢ=\tilde{H}_{1,i}x_{1,i}+ñᵢ

where \tilde{H}_{1,i}=Rᵤᵤ^{-1/2}H_{1,i} and E[ñᵢñ*ᵢ]=I_{N}_{ᵣ}. The LLRs may be computed by a detection circuit 700B depicted in FIG. 7B.

The detection circuit 700B is similar to the detection circuit 700A of FIG. 7A, except that the detection circuit 700B may not include the signal selection circuit 710, and the M-spatial stream MLM detector 740 is replaced by a 4×4 MLM detector 750. In some aspects, the detection circuit 700B may be one implementation of the detection circuit 312 of FIG. 3 and/or one implementation of the detection circuit 412 of FIG. 4. In other aspects, the functions performed by the detection circuit 700B may be implemented by executing one or more of the software programs or instructions stored in memory 340 of FIG. 3 (e.g., by processor 330) and/or may be implemented by executing one or more of the software programs or instructions stored in memory 440 of FIG. 4 (e.g., by processor 430). Operation of the detection circuit 700B is similar to the operation of detection circuit 700A described above with respect to FIG. 7A, except that for the detection circuit 700B, there is only one user. As a result, the signal selection circuit 710 and the MUX 760 of FIG. 7A may be omitted from the detection circuit 700B of FIG. 7B.

FIG. 8 is an illustrative flow chart depicting an example operation 800 for receiving or obtaining wireless signals, in accordance with aspects of the present disclosure. The example operation 800 may be performed by any suitable wireless device including, for example, the access point 110 of FIGS. 1-2, the user terminals 120 of FIGS. 1-2, the wireless device 300 of FIG. 3, and/or the AP 400 of FIG. 4. As described below, the example operation 800 may be performed by a first wireless device to distinguish between signals containing data intended for the first wireless device and signals containing data intended for a number of second wireless devices.

The first wireless device may obtain a wireless signal including a first signal and a number of second signals (802). For example, the first wireless device may receive the wireless signal via one or more of antennas 350(1)-350(n) of wireless device 300 of FIG. 3, or one or more of antennas 460(1)-460(n) of AP 400 of FIG. 4. In some aspects, the first signal may contain data intended for the first wireless device, and each of the number of second signals may contain data intended for one or more second wireless devices (802A).

The first wireless device may select one or more of the number of second signals (804). As described above, the selected ones of the second signals may be excluded from determining a pre-whitening matrix. For example, the first wireless device may select the one or more second signals for exclusion from determining the pre-whitening matrix by executing the signal selection software module 343 of FIG. 3 or by executing the signal selection software module 443 of FIG. 4.

The first wireless device may determine a pre-whitening matrix based on an interference and noise covariance of the unselected second signals (806). In some aspects, determining the pre-whitening matrix may include excluding an interference and noise covariance of the selected ones of the second signals. For example, the first wireless device may determine the pre-whitening matrix by executing the covariance estimation software module 344 and/or the pre-whitening software module 345 of FIG. 3 or by executing the covariance estimation software module 444 and/or the pre-whitening software module 445 of FIG. 4. For other implementations, the pre-whitening matrix may be applied to the received wireless signal and to a channel response of the first signal.

The first wireless device may generate a pre-whitened signal by applying the pre-whitening matrix to the wireless signal (808). For example, the first wireless device may generate the pre-whitened signal by executing the pre-whitening software module 345 of FIG. 3 or by executing the pre-whitening software module 445 of FIG. 4.

The first wireless device may recover the first signal by using the pre-whitened signal (810). For example, the first wireless device may recover the first signal by executing the detector software module 346 of FIG. 3 or by executing the detector software module 446 of FIG. 4. In some aspects, the first wireless device may determine the modulation constellation for each of the selected one or more second signals based on one or more high-efficiency (HE) preamble fields of the wireless signal (810A). The first wireless device may associate a modulation constellation with each of the selected second signals (810B), and then apply the associated one or more modulation constellation(s) when recovering the first signal (810C). For other implementations, the first wireless device may recover the first signal by using the pre-whitened signal and the pre-whitened channel response.

For other implementations, the first wireless device may perform the example operation 800 using any one or more of detection circuit 500A of FIG. 5A, detection circuit 500B of FIG. 5B, detection circuit 600 of FIG. 6, detection circuit 700A of FIG. 7A, and/or detection circuit 700B of FIG. 7B.

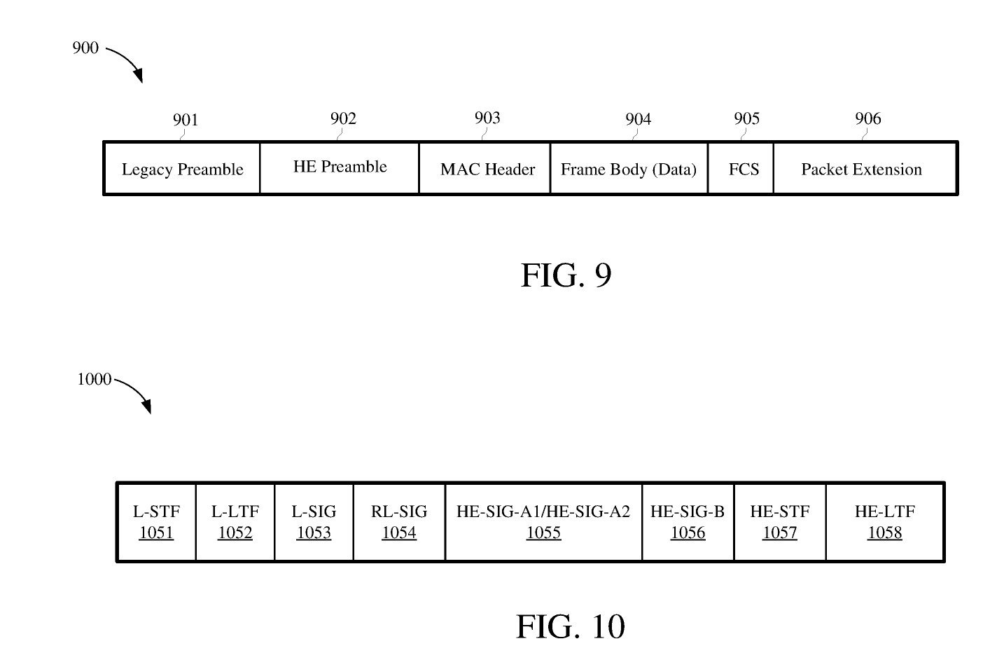

FIG. 9 shows an example high efficiency (HE) packet 900 that may be used with aspects of the present disclosure. The HE packet 900 is shown to include a legacy preamble 901, a HE preamble 902, a MAC header 903, a frame body 904, a frame check sequence (FCS) field 905, and a packet extension 906.

The legacy preamble 901 may include synchronization information, timing information, frequency offset correction information, and signaling information. The HE preamble 902 may also include synchronization information, timing information, frequency offset correction information, and signaling information.

The MAC header 903 may contain information describing characteristics or attributes of data encapsulated within the frame body 904, may include a number of fields indicating source and destination addresses of the data encapsulated within the frame body 904, and may include a number of fields containing control information. More specifically, although not shown in FIG. 9 for simplicity, the MAC header 903 may include, for example, a frame control field, a duration field, a destination address field, a source address field, a BSSID field, and a sequence control field.

The frame body 904 may store data including, for example, one or more information elements (IEs) that may be specific to the frame type indicated in the MAC header 903. The FCS field 905 may include information used for error detection and data recovery. The packet extension 906 may include “dummy” data, for example, to allow a receiving device more time to decode HE packet 900 without giving up medium access.

FIG. 10 shows an example preamble 1000 of an HE packet that may be used with aspects of the present disclosure. The preamble 1000, which may be one implementation of the preamble 901 and preamble 902 of HE packet 900 of FIG. 9, may be compliant with the IEEE 802.11 ax standards. The preamble 1000 is shown to include a Legacy Short Training Field (L-STF) 1051, a Legacy Long Training Field (L-LTF) 1052, a Legacy Signal (L-SIG) field 1053, a Repeated Legacy Signal (RL-SIG) field 1054, a set of HE Signal-A (HE-SIG-A1/HE-SIG-A2) fields 1055, a HE Signal B (HE-SIG-B) field 1056, a HE Short Training Field (HE-STF) 1057, and an HE Long Training Field (HE-LTF) 1058.

The L-STF 1051 may include information for coarse frequency estimation, automatic gain control, and timing recovery. The L-LTF 1052 may include information for fine frequency estimation, channel estimation, and fine timing recovery.

The L-SIG field 1053 may include modulation and coding information. The HE-SIG-Al and HE-SIG-A2 fields 1055 may include parameters such as an indicated bandwidth, a payload guard interval (GI), a coding type, a number of spatial streams (Nsts), a space-time block coding (STBC), beamforming information, and so on. More specifically, the HE-SIG-A1 and HE-SIG-A2 fields 1055 may include a set of fields to store parameters describing the type of information stored in the HE-LTF 1058. For example, the set of fields includes (1) a CP+LTF Size field that stores a cyclic prefix (CP) value and a length of the HE-LTF 1058; (2) an Nsts field to store information indicating the number spatial streams, (3) a STBC field store a value for space-time block coding, and (4) a transmit beamforming (TxBF) field to store information pertaining to beamforming. In some aspects, a number of bits provided within the HE-SIG-B field 1056 may be used to indicate the modulation constellation of an interfering signal.

Information contained in the HE-STF 1057 may be used to improve automatic gain control estimates for SU-MIMO and MU-MIMO communications, and information contained in the HE-LTF 1058 may be used to estimate various MIMO channel conditions. In some aspects, a number of bits provided within the HE-LTF 1058 may be used to indicate the modulation constellation of an interfering signal.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, in some aspects, a means for obtaining a wireless signal may comprise a receiver (e.g., the receiver unit 222) and/or an antenna(s) 224 of the access point 110 illustrated in FIG. 2 or the transceivers 411 and antennas 460 of the AP 400 depicted in FIG. 4. In other aspects, the means for obtaining a wireless signal may comprise a receiver (e.g., the receiver unit 254) and/or an antenna(s) 252 of the UT 120 illustrated in FIG. 2 or the transceivers 311 and antennas 350 of the wireless device 300 depicted in FIG. 3. Further, for some implementations, the means for obtaining a wireless signal may comprise an interface, for example, as described above with respect to FIGS. 1-4.

In some aspects, a means for selecting one or more of the number of second signals may comprise the signal selection circuit 510 depicted in FIGS. 5A- 5 B and 6 or the signal selection circuit 710 depicted in FIG. 7A. In other aspects, the means for selecting one or more of the number of second signals may comprise a processing system disclosed herein (e.g., the processing system 335 of FIG. 3 or the processing system 435 of FIG. 4).

In some aspects, a means for determining a pre-whitening matrix based on an interference and noise covariance of the unselected second signals may comprise the covariance estimation circuit 520 depicted in FIGS. 5A-5B and 6 or the covariance estimation circuit 720 depicted in FIGS. 7A-7B. In other aspects, the means for determining the pre-whitening matrix may comprise a processing system disclosed herein (e.g., the processing system 335 of FIG. 3 or the processing system 435 of FIG. 4).

In some aspects, a means for generating a pre-whitened signal by applying the pre-whitening matrix to the wireless signal may comprise the pre-whitening circuit 530 depicted in FIGS. 5A-5B and 6 or the pre-whitening circuit 730 depicted in FIGS. 7A-7B. In other aspects, the means for generating the pre-whitened signal may comprise a processing system disclosed herein (e.g., the processing system 335 of FIG. 3 or the processing system 435 of FIG. 4).

In some aspects, a means for recovering the first signal by using the pre-whitening signal may comprise the detector 540 depicted in FIG. 5A, the detector 550 depicted in FIG. 5B, the detector 610 depicted in FIG. 6, the detector 740 depicted in FIG. 7A, or the detector 750 depicted in FIG. 7B. In other aspects, the means for recovering the first signal may comprise a processing system disclosed herein (e.g., the processing system 335 of FIG. 3 or the processing system 435 of FIG. 4).

In some aspects, a means for determining the modulation constellation for each of the selected one or more second signals, a means for associating the modulation constellation, and a means for applying the one or more associated modulation constellations when recovering the first signal may comprise the detector 600 depicted in FIG. 6. Further, in some aspects, a means for estimating the modulation constellation may comprise the detector 600 depicted in FIG. 6.

In some cases, rather than actually transmitting a frame a device may have an interface to output a frame for transmission. For example, a processor may output a frame, via a bus interface, to a radio frequency (RF) front end for transmission. Similarly, rather than actually receiving a frame, a device may have an interface to obtain a frame received from another device. For example, a processor may obtain (or receive) a frame, via a bus interface, from an RF front end for reception.

According to certain aspects, such means may be implemented by processing systems configured to perform the corresponding functions by implementing various algorithms (e.g., in hardware or by executing software instructions) described above for generating frames for transmission during a sector sweep procedure.

As used herein, the term “generating” encompasses a wide variety of actions. For example, “generating” may include calculating, causing, computing, creating, determining, processing, deriving, investigating, making, producing, providing, giving rise to, leading to, resulting in, looking up (e.g., looking up in a table, a database or another data structure), ascertaining and the like. Also, “generating” may include receiving (e.g., receiving information), accessing (e.g., accessing data in a memory) and the like. Also, “generating” may include resolving, selecting, choosing, establishing and the like.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Also, “determining” may include measuring, estimating and the like.

As used herein, a phrase referring to “at least one of” a list of items refers to any combination of those items, including single members. As an example, “at least one of: a, b, or c” is intended to cover a, b, c,a-b,a-c, b-c, anda-b-c, as well as any such list including multiples of the same members (e.g., any lists that include aa, bb, or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
an interface configured to obtain a wireless multi-user multiple-input multiple-output (MU-MIMO) signal including a first spatial stream and second spatial streams; and
a processing system configured to:
select one or more of second spatial streams;
determine a pre-whitening matrix based on an interference and noise covariance of unselected second spatial streams and excluding an interference and noise covariance of the selected one or more second spatial streams;
generate a pre-whitened signal by applying the pre-whitening matrix to the wireless MU-MIMO signal; and
recover the first spatial stream by using the pre-whitened signal.

2. (canceled)

3. The apparatus of claim 1, wherein the one or more second spatial streams are selected based on a correlation metric to indicate a correlation between the second spatial streams and the first spatial stream.

4. The apparatus of claim 1, wherein the one or more second spatial streams are selected based on a power metric.

5. The apparatus of claim 1, wherein the selection comprises selecting the one or more second spatial streams if an amount of energy spillover into a channel corresponding to the first spatial stream equals a threshold value.

6. The apparatus of claim 1, wherein the processing system is further configured to generate a pre-whitened channel response by applying the pre-whitening matrix to a channel response of the first spatial stream.

7. The apparatus of claim 6, wherein the recovery comprises recovering the first spatial stream by using the pre-whitened signal and the pre-whitened channel response.

8. The apparatus of claim 1, wherein the processing system is further configured to:
associate a modulation constellation with each of the selected one or more second spatial streams; and
apply the one or more associated modulation constellations when recovering the first spatial stream.

9. The apparatus of claim 8, wherein the association comprises:
determining the modulation constellation for each of the selected one or more second signals spatial streams based on one or more high efficiency (HE) preamble fields of the wireless MU-MIMO signal.

10. The apparatus of claim 8, wherein the association comprises:
estimating the modulation constellation for each of the selected one or more second spatial streams based on one or more preamble fields of the wireless MU-MIMO signal.

11. A method for wireless communication, comprising:
obtaining a wireless multi-user multiple-input multiple-output (MU-MIMO) signal including a first spatial stream and second spatial streams;
selecting one or more second spatial streams;
determining a pre-whitening matrix based on an interference and noise covariance of unselected second spatial streams and excluding an interference and noise covariance of the selected one or more second spatial streams;
generating a pre-whitened signal by applying the pre-whitening matrix to the wireless MU-MIMO signal; and
recovering the first spatial stream by using the pre-whitened signal.

12. (canceled)

13. The method of claim 11, wherein the one or more second spatial streams are selected based on a correlation metric indicating a correlation between the second spatial streams and the first spatial stream.

14. The method of claim 11, wherein the one or more second spatial streams are selected based on a power metric.

15. The method of claim 11, wherein the one or more second spatial streams are selected if an amount of energy spillover into a channel corresponding to the first spatial stream equals a threshold value.

16. The method of claim 11, further comprising:
generating a pre-whitened channel response by applying the pre-whitening matrix to a channel response of the first spatial stream.

17. The method of claim 16, wherein the first spatial stream is recovered by using the pre-whitened signal and the pre-whitened channel response.

18. The method of claim 11, further comprising:
associating a modulation constellation with each of the selected one or more second spatial streams; and
applying the associated modulation constellations when recovering the first spatial stream.

19. The method of claim 18, wherein associating the modulation constellation comprises:
determining the modulation constellation for each of the selected one or more second spatial streams based on one or more high efficiency (HE) preamble fields of the wireless MU-MIMO signal.

20. The method of claim 18, wherein associating the modulation constellation comprises:
estimating the modulation constellation for each of the selected one or more second spatial streams based on one or more preamble fields of the wireless MU-MIMO signal.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A wireless node comprising:
a receiver configured to receive a wireless multi-user multiple-input multiple-output (MU-MIMO) signal including a first spatial stream and second spatial streams; and
a processing system configured to:
select one or more second spatial streams;
determine a pre-whitening matrix based on an interference and noise covariance of unselected second spatial streams and excluding an interference and noise covariance of the selected one or more second spatial streams;
generate a pre-whitened signal by applying the pre-whitening matrix to the wireless MU-MIMO signal; and
recover the first spatial stream by using the pre-whitened signal.
